(19) United States
(12) Patent Application Publication
(10) Pub. No.: US 2003/0075117 A1
(43) Pub. Date: Apr. 24, 2003

(54) Multifunctional favor animal box

(76) Inventor: Hsun Chin Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/036,130

(22) Filed: Oct. 19, 2001

(51) Int. Cl. A01K 23/00

(52) U.S. Cl. 119/867

(57) ABSTRACT

The present invention is accessory to U.S. Pat. No. 5,970,922, and proposes a multifunctional favor animal box. The present invention is characterized in that a first inner cup and a second inner cup, which are made of paper and can telescope with each other to form a unity, are provided to receive dung of favor animal. The first inner cup and the second inner cup can be discarded along with the dung of favor animal dung without the need of cleaning so that better sanitation can be achieved.

### FIELD OF THE INVENTION

The present invention is accessory to U.S. Pat. No. 5,970,922, and relates to a multifunctional favor animal box and, more particularly, to a multifunctional favor animal box, which can be hung on the neck of a favor animal to facilitate cleaning of the favor animal's dung, and can be discarded without the need of cleaning, hence more conforming to sanitary requirement.

### BACKGROUND OF THE INVENTION

In U.S. Pat. No. 5,970,922, a multifunctional favor animal box comprising a box body, a cover, and a carrying body is disclosed. The box body has an opening at an end thereof. The cover can cover the opening of the box body. A cylinder is extended from the inner side of the cover, and can be received within the box body. A holding portion is formed outside the cover. The carrying body is properly connected to the outer wall of the box body. The above multifunctional favor animal box can be used as a shovel, a container, etc. for cleaning the dung of favor animal, which can be carried by the favor animal itself. Because the favor animal box has a beautiful outlook, and the favor animal's dung is sealed inside the favor animal box, the user has no inelegant and unsanitary doubts.

However, after the above multifunctional favor animal box is used, the box body and the cover will look dirty because there is favor animal's dung adhering thereon. Therefore, they must be cleaned constantly, resulting in inconvenience of the user. Moreover, the user must endure malodor of dung during the cleaning process so that sanitary consideration cannot be overlooked.

Furthermore, after the favor animal's dung is received inside the favor animal box, it must be dumped out into a rubbish bin betimes. Because the dumped dung is exposed outside, there is some sanitary consideration.

### SUMMARY OF THE INVENTION

Accordingly, the primary object of the present invention is to provide a multifunctional favor animal box having a first inner cup and a second inner cup, which can be discarded along with dung of favor animal without the need of cleaning. Therefore, the user needs not to endure malodor of dung during the cleaning process so that better sanitation can be achieved.

Another object of the present invention is to provide a multifunctional favor animal box, whereby dung of favor animal is wrapped inside the first inner cup and the second inner cup when dumped out. The dung of favor animal will not be exposed outside so that better sanitation can be achieved.

To achieve the above objects, the present invention provides a multifunctional favor animal box, which comprises a box body, a cover, a carrying body, a first inner cup, and a second inner cup. The box body has an opening at an end thereof. The cover can cover the opening of the box body. The carrying body is properly connected to the outer wall of the box body. The first inner cup is placed inside the box body. The second inner cup can be telescoped with the first inner cup to form a unity, which can be discarded without the need of cleaning. A multifunctional favor animal box more conforming to sanitary requirement is thus formed.

The various objects and advantages of the present invention will be more readily understood from the following detailed description when read in conjunction with the appended drawings, in which:

### BRIEF DESCRIPTION OF THE DRAWINGS

FIG. 1 is a perspective view of the present invention;

FIG. 2 is an exploded perspective view of the present invention;

FIG. 3 is a plan cross-sectional view of the present invention;

FIG. 4 is a schematic view of the present invention showing the usage of the present invention.

FIG. 5 is a plan cross-sectional view according to another embodiment of the present invention.

### DETAILED DESCRIPTION OF THE PREFERRED EMBODIMENTS

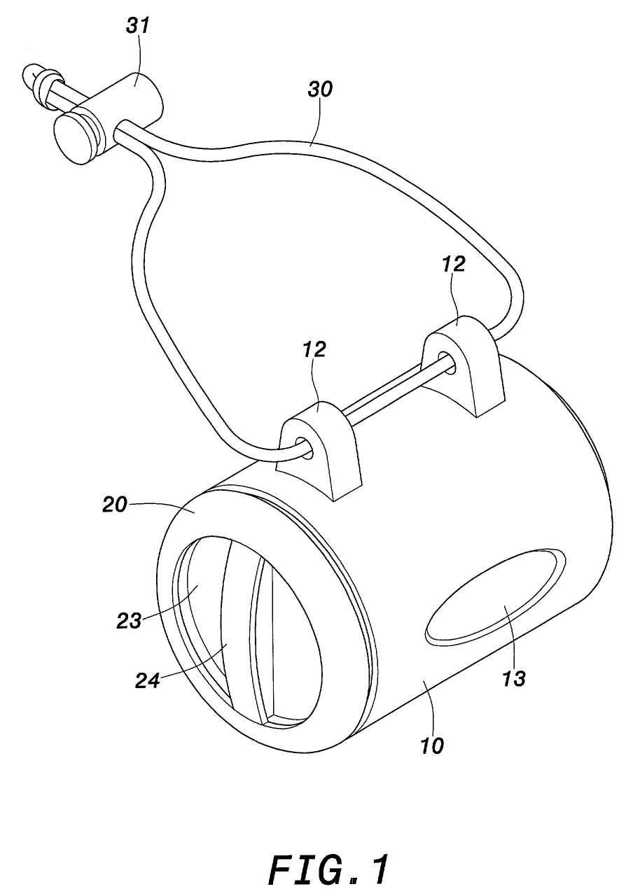

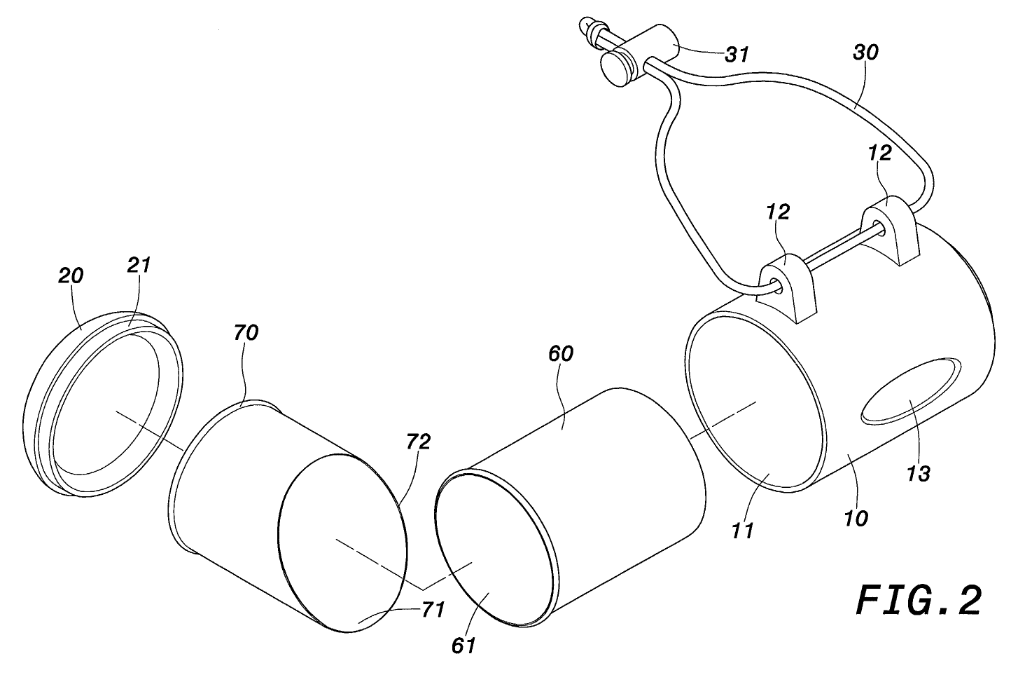

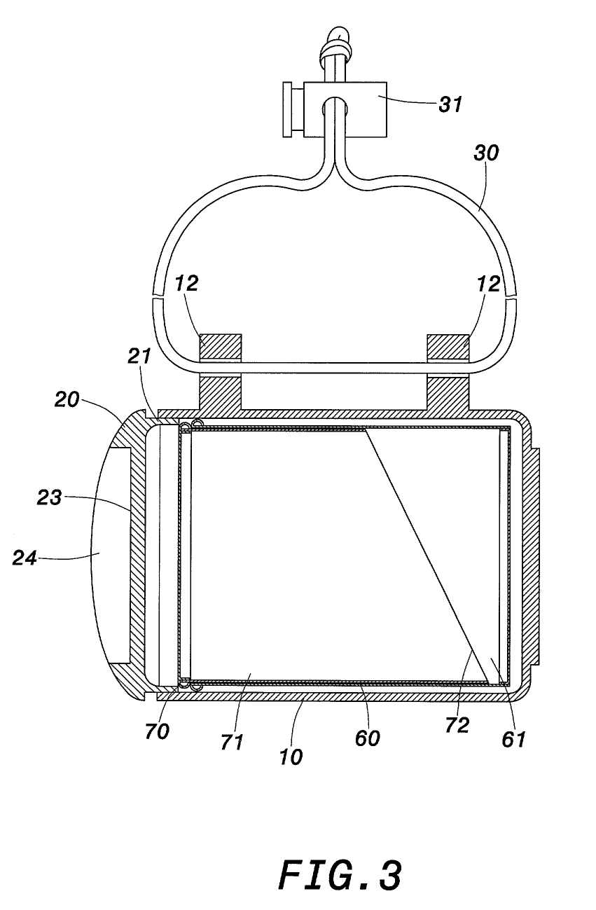

As shown in FIGS. 1 to 3, the present invention provides a multifunctional favor animal box, which comprises a box body 10, a cover 20, a carrying body 30, a first inner cup 60, and a second inner cup 70. The box body 10 is a hollow body, and has an opening 11 at an end thereof. Two hole seats 12 are projectively disposed on the outer wall of the box body 10. A depressed portion 13 can be disposed on the outer wall of the box body 10 to facilitate embedding or pasting of a nameplate for recording the address, name, or other information about the favor animal.

The cover 20 can be matched with the opening 11 of the box body 10. The inner side of the cover 20 near the periphery thereof extends to form an annular retaining portion 21 to be retained with the opening 11 of the box body 10 so that the box body 10 and the cover 20 can be assembled to become a sealed container. A plurality of cavities 23 not penetrating to the inside are disposed at the outside of the cover 20 to form a holding portion 24. The user's fingers can stick into the cavities 23 to hold the holding portion 24, hence facilitating operation of the cover 20.

The carrying body 30 is made of flexible material such as rope. The carrying body 30 is ring-shaped, and passes through the hole seats 12 on the outer wall of the box body 10 so that the carrying body 30 can be joined on the outer wall of the box body 10. An adjustment element 31 can be joined on the carrying body 30 to adjust the size of the ring formed by the carrying body 30.

The first inner cup 60 is made of paper, and is a hollow body. An opening 61 is formed at an end of the first inner cup 60 to let the first inner cup 60 form a paper cup. The outer diameter of the first inner cup 60 is smaller than the inner diameter of the box body 10 so that the first inner cup 60 can be placed inside the box body 10.

The second inner cup 70 is also made of paper,and is a hollow bodyAn opening 71 is formed at an end of the second inner cup 70 to let the second inner cup 70 form a paper cup. The outer diameter of the second inner cup 70 is smaller than the inner diameter of the first inner cup 60 so that the second inner cup 70 can be inserted into the first inner cup 60. The first inner cup 60 and the second inner cup 70 can thus be telescoped with each other to form a unity. An end of the second inner cup 70 forms a slanting end 72 to facilitate shoveling of dung of favor animal. A multifunctional favor animal box of the present invention is thus formed. The favor animal box can be manufactured into different sizes to apply to favor animals of different builds (e.g., dogs).

Additionally, the box body 10 and the cover 20 can also be made of transparent material. Color markings or patterns can be printed on the outer surfaces of the first inner cup 60 and the second inner cup 70 to be shown through the transparent box body 10 and cover 20, hence having high-quality and vivid feeling.

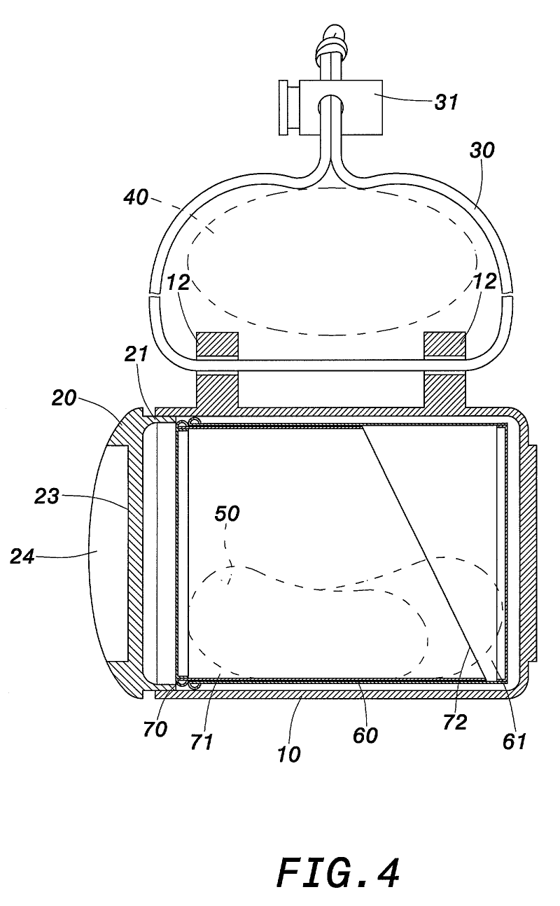

As shown in FIG. 4, the favor animal box of the present invention can be hung at a favor pet's neck 40 via the carrying body 30 to let the favor animal carry the favor animal box itself. When the favor animal excretes dung, the user can open the cover 20 and use the second inner cup 70 as a shovel to shovel the dung 50 of favor animal. Afterwards, the second inner cup 70 and the first inner cup are telescoped with each other to form a unity with the dung 50 of favor animal received therein. The cover 20 then covers the opening 11 of the box body 10 to let the box body 10 and the cover 20 form a sealed container. The favor animal's dung 50 can thus be received inside the cover 20 and the box body 10, i.e., inside the favor animal box.

The favor animal box of the present invention can be used as a shovel, a container, etc. for cleaning the dung of favor animal, which can be carried by the favor animal itself. Because the favor animal box has a beautiful outlook, and the dung of favor animal is sealed inside the favor animal box, the user has no inelegant and unsanitary doubts. Additionally, a nameplate recording the address, name, or other information of favor animal can be pasted at the depressed portion 13 or other positions on the outer wall of the box body 10 so that the present invention has also the function of a nameplate for identification when the favor animal strays.

The present invention is characterized in that the first inner cup 60 and the second inner cup 70, which are made of paper, are provided to receive the dung 50 of favor animal. The first inner cup 60 and the second inner cup 70 can be discarded along with the dung 50 of favor animal without the need of cleaning. Therefore, the user needs not to endure malodor of dung during the cleaning process so that better sanitation can be achieved.

Moreover, the dung 50 of favor animal is wrapped inside the first inner cup 60 and the second inner cup 70 when dumped out. The dung 50 of favor animal will not be exposed outside so that better sanitation can be achieved

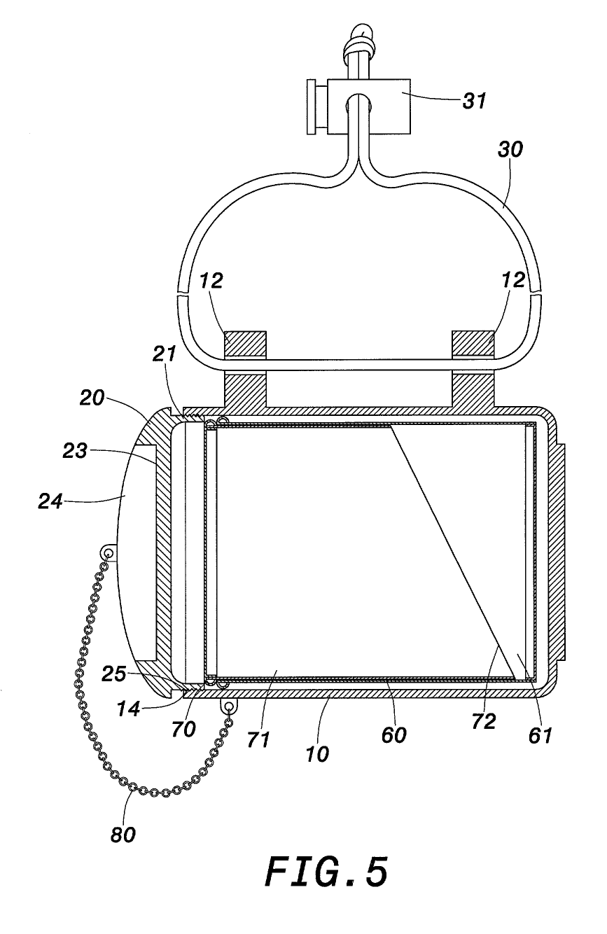

Additionally, as shown in FIG. 5, the box body 10 and the cover 20 can also have corresponding threads 14 and 25 so that the box body 10 and the cover 20 can be screwed together to form a sealed container. A chain 80 can also be connected between the box body 10 and the cover 20, hence preventing from missing the cover 20.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A multifunctional favor animal box, comprising:
a box body having an opening at an end thereof;
a cover capable of covering said opening of said box body;
a carrying body properly joined on an outer wall of said box body;
a first inner cup placed inside said box body; and
a second inner cup capable of telescoping with said first inner cup.

2. The multifunctional favor animal box as claimed in claim 1, wherein hole seats are projectively disposed on the outer wall of said box body, and said carrying body passes through said hole seats on the outer wall of said box body to let said carrying body and said box body be joined together.

3. The multifunctional favor animal box as claimed in claim 1, wherein a depressed portion is disposed on the outer wall of said box body to facilitate embedding or pasting of a nameplate.

4. The multifunctional favor animal box as claimed in claim 1, wherein said box body and said cover can have corresponding screws so that they can be screwed together to form a sealed container.

5. The multifunctional favor animal box as claimed in claim 1, wherein a chain is disposed between said box body and said cover to connect them.

6. The multifunctional favor animal box as claimed in claim 1, wherein said box body and said cover can be made of transparent material, and color markings or patterns are printed on outer surfaces of said first inner cup and said second inner cup.

7. The multifunctional favor animal box as claimed in claim 1, wherein a retaining portion is formed at an inside of said cover to be fixedly retained at said opening of said box body.

8. The multifunctional favor animal box as claimed in claim 1, wherein a plurality of cavities not penetrating to inside are disposed at an outside of said cover to form a holding portion.

9. The multifunctional favor animal box as claimed in claim 1, wherein an adjustment element is joined on said carrying body to adjust the size of said carrying body.

10. The multifunctional favor animal box as claimed in claim 1, wherein said first inner cup and said second inner cup are made of paper, and each of them has an opening at an end thereof.

11. The multifunctional favor animal box as claimed in claim 1, wherein an end of said second inner cup forms a slanting end.

12. The multifunctional favor animal box as claimed in claim 1, wherein the outer diameter of said second inner cup is smaller than the inner diameter of said first inner cup so that said second inner cup can be inserted into said first inner cup.
